(19) United States
(12) Patent Application Publication
(10) Pub. No.: US 2001/0008478 A1
(43) Pub. Date: Jul. 19, 2001

(54) Linear capacitance measurement circuit

(76) Inventors: Robert B. McIntosh, Alexandria, VA (US); Winfield Hill, Stoneham, MA (US)

Correspondence Address: Robert B. McIntosh, 309 Vassar Road, Alexandria, VA, 22314, US

(21) Appl. No.: 09/794,198

(22) Filed: Feb. 27, 2001

Related U.S. Application Data
(63) Continuation-in-part of application No. 09/482,119, filed on Jan. 13, 2000.
(63) Continuation-in-part of application No. 09/037,733, filed on Mar. 10, 1998, now Pat. No. 6,151,967.

(51) Int. Cl. H01H 73/00; G01P 15/125

(52) U.S. Cl. 361/115; 73/514.32

(57) ABSTRACT

A capacitive measurement circuit detects a change in capacitance between a variable capacitor and a fixed reference capacitor in a bridge network and provides feedback current to null-balance the bridge. Voltage that controls the feedback current is substantially linearly proportional to changes in capacitance over a wide range.

### CROSS-REFERENCE TO RELATED APPLICATIONS

This application is a continuation-in-part of divisional application Ser. No. 09/482,119, Jan. 13, 2000, of application Ser. No. 09/037,733 of Mar. 10, 1998, now U.S. Pat. No. 6,151,967, each of which is incorporated by reference in its entirety. All of the applications are assigned to the same assignee as the present application.

### GOVERMENT RIGHTS

This invention was made with Government support under contract N00024-97-C-4157 from the Naval Sea Systems Command. The Government has certain rights to this invention

### FIELD OF THE INVENTION

The present invention relates in general to electronic circuits used to measure capacitance and more specifically to precision, low-noise, capacitive measurement circuits with a linear response for large changes of capacitance.

### BACKGROUND OF THE INVENTION

Many electronic circuits have been devised to transduce a change of capacitance of a variable capacitor, but none provide a linear output for the large changes in capacitance of variable capacitors of U.S. Pat. No. 6,151,967. The performance of many capacitance transducers can be enhanced if a capacitive measurement circuit is available that has the following combination of advantages:

a. an output voltage that is linear with large changes of capacitance;

b. A measurement bandwidth that extends from DC to a predetermined cutoff frequency;

c. a bridge network in which an electrode of variable capacitors is grounded;

d. a low-impedance bridge that minimizes the thermal noise of passive components and the current noise of amplifying means;

e. a bridge that minimizes noise and errors due to timing variations of an excitation waveform;

f. a circuit in which DC stability is established by high-gain current feedback;

g. a bridge that minimizes signal division by fixed elements and uses a majority of the time during an excitation cycle to develop a measurement signal;

h. A feedback circuit in which optional low-pass filtering ahead of amplification reduces input signal excursion and avoids amplifying bridge excitation frequencies;

i. a circuit for which active shielding can be easily and effectively implemented.

Prior art capacitive measurement circuits do not have a combination of all the above advantages. Capacitance measurement circuits that use feedback to achieve a linear response generally do not utilize low-impedance components or allow an electrode of variable capacitors to be grounded. By contrast, low-impedance circuits generally have a linear response over a very limited range.

Accordingly, the present invention was developed to provide a capacitance measurement circuit with the above advantages to enhance the performance of capacitance transducers.

### SUMMARY OF THE INVENTION

A general object of the present invention is to provide an improved capacitive measurement circuit with a linear output for large changes of capacitance compared to prior art capacitive measurement circuits.

In accordance with one embodiment of this invention, a capacitance bridge network with a variable capacitor is null-balanced by feedback current from a high-gain transconductance amplifier with an output voltage that is substantially linearly proportional to a change in capacitance of said variable capacitor.

### DESCRIPTION OF THE DRAWINGS

Further objects and advantages of the present invention will become apparent from the following description of the preferred embodiments when read in conjunction with the appended drawings, wherein like reference characters generally designate similar parts or elements with similar functions, and in which:

FIG. 1 is a circuit diagram of a bridge network included in one embodiment of a linear capacitive measurement circuit of the present invention;

FIGS. 2A-D are timing diagrams for electrical signals of the bridge network of FIG. 1;

FIG. 3 is a circuit diagram of a transposed bridge network included in a second embodiment of a linear capacitive measurement circuit of the present invention;

FIGS. 4A-B are timing diagrams for electrical signals of the bridge network of FIG. 3;

FIG. 5 is a simplified circuit diagram of a preferred embodiment of a linear capacitive measurement circuit of the present invention;

FIG. 6 is a plot of output voltage vs. capacitance for a transposed circuit of the capacitance measurement circuit of FIG. 5;

FIG. 7 is a simplified circuit diaphragm of a simpler embodiment of a linear capacitive measurement circuit that includes a half-bridge network;

FIG. 8 is a plot of output voltage vs. capacitance for capacitive measurement circuit of FIG. 7;

FIG. 9 is an illustration of an active shield circuit arrangement.

### DETAILED DESCRIPTION OF PREFERRED EMBODIMENTS

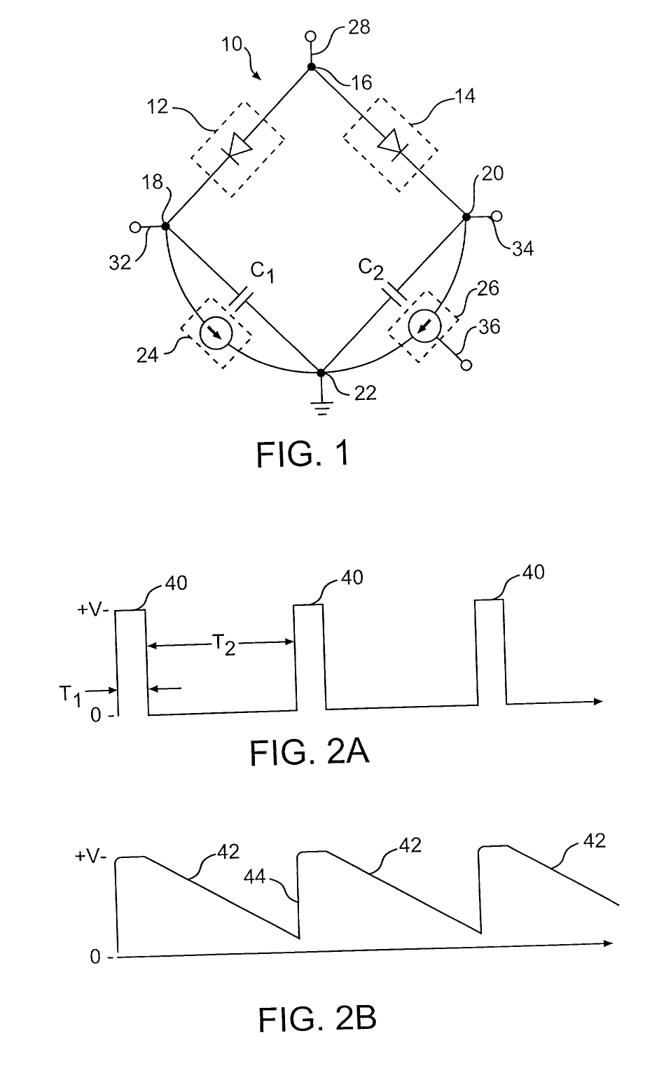

A bridge network included in one embodiment of a capacitance measurement circuit of the present invention is generally shown by reference numeral 10 in FIG. 1. A first terminal of isolation means 12 and 14 is connected to a first common node 16 and a second terminal of isolation means 12 and 14 is connected to a second common node 18 and to a third common node 20 respectively. Capacitors C₁ and C₂ are connected between a fourth common node 22 and nodes 18 and 20 respectively. A current sourcing means 24 is connected between nodes 18 and 22 and a voltage-controlled current sourcing means 26 is connected between nodes 20 and 22. A bridge excitation voltage terminal 28 is connected to node 16 and node 22 is connected to a reference potential. Signal terminals 32 and 34 are connected to nodes 18 and 20 respectively and voltage control terminal 36 is connected to voltage-controlled current sourcing means 26.

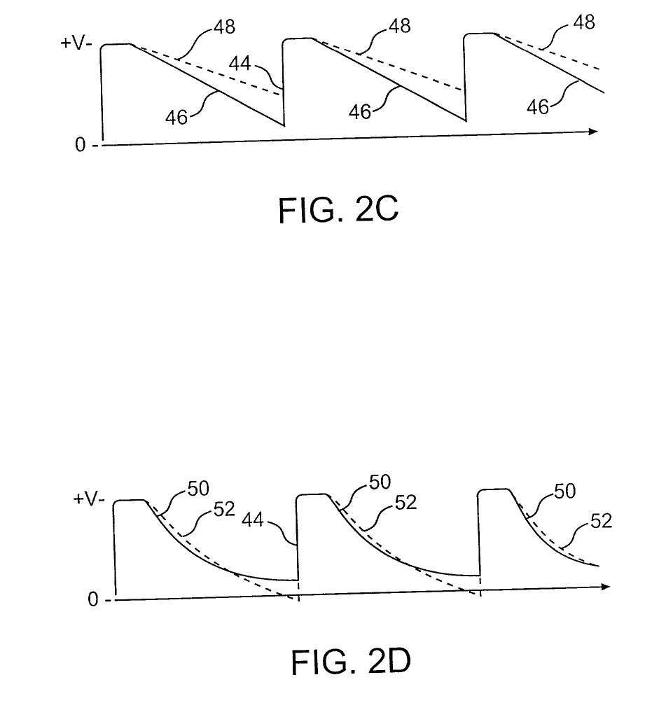

The operation of bridge network 10 is described with reference to timing diagrams of FIGS. 2A-D. FIG. 2A shows a train of periodic pulses 40 with voltage amplitude +V applied to excitation voltage terminal 28. During time T₁, isolation means 12 and 14 electrically conduct allowing capacitors C₁ and C₂ to rapidly charge to voltage +V, less any residual voltage drop across isolation means 12 and 14. At the end of time T₁, pulse 40 ends causing isolation means 12 and 14 to stop conducting. During time T₂, the voltages across capacitors C₁ and C₂ decrease at a rate determined by the magnitude of current sunk by current sourcing means 24 and by voltage-controlled current sourcing means 26 respectively. FIG. 2B shows the resulting voltage waveform 42 across capacitor C₁ at node 18, and FIG. 2C shows voltage waveform 46 across C₂ at node 20 when capacitors C₁ and C₂ are of equal value and when current sourcing means 24 and 26 sink identical current. For this balanced condition, the periodic voltage at nodes 18 and 20 will be substantially equal and waveform 42 of FIG. 2B will be substantially identical to waveform 46 of FIG. 2C. If the value of capacitor C₂ increases when current sourcing means 24 and 26 sink identical currents, a new voltage waveform 48 develops at node 20 with a higher average value than waveform 46.

One embodiment of a capacitive measurement circuit of this invention is based upon using the difference between the voltage, or a running average of the voltage, between nodes 18 and 20 of FIG. 1 as an error signal in a negative feedback circuit arrangement. This error signal is amplified at high gain to provide a voltage V to control current sourcing means 26 to null-balance the periodic voltage at nodes 18 and 20. When C₂ is greater that C₁, voltage at terminal 36 causes current from voltage-controlled current sourcing means 26 to increase to force waveform 48 of FIG. 2C to have the general contour of waveform 46. At balance, waveform 46 is substantially identical to waveform 42 of FIG. 2B and the change in voltage ΔV at terminal 36 is proportional to ΔC₂/C₂. This relationship remains substantially linear for large values of ΔC₂.

Current sourcing means 24 can comprise a common resistor, a transistor current source, a transistor current conveyor, a multiple transistor current source, a fixed voltage-to-current convertor, or a voltage-biased current mirror. Voltage-controlled current sourcing means 26 can be a resistor, a voltage-controlled current source, a voltage-controlled current conveyor, a voltage programmed current convertor, or a voltage-controlled current mirror. If current sourcing means 24 in bridge network 10 is replaced by a resistor, the voltage on C₁ discharges exponentially to an asymptote determined by a reference potential during time T₂. In this case, the voltage at node 18 comprises a periodic waveform of exponentially decaying pulses 50 of FIG. 2D.

The advantages of the present invention can be realized by detecting and actively nulling the difference between the running averages of the voltage waveforms at nodes 18 and 20 of circuit 10. For this case the exact shape of the waveforms need not be precisely matched. For example, in a half-bridge embodiment of a simpler capacitive bridge circuit, an average value of a periodic voltage across variable capacitor C₂ is controlled by a fixed bias voltage applied to node 18.

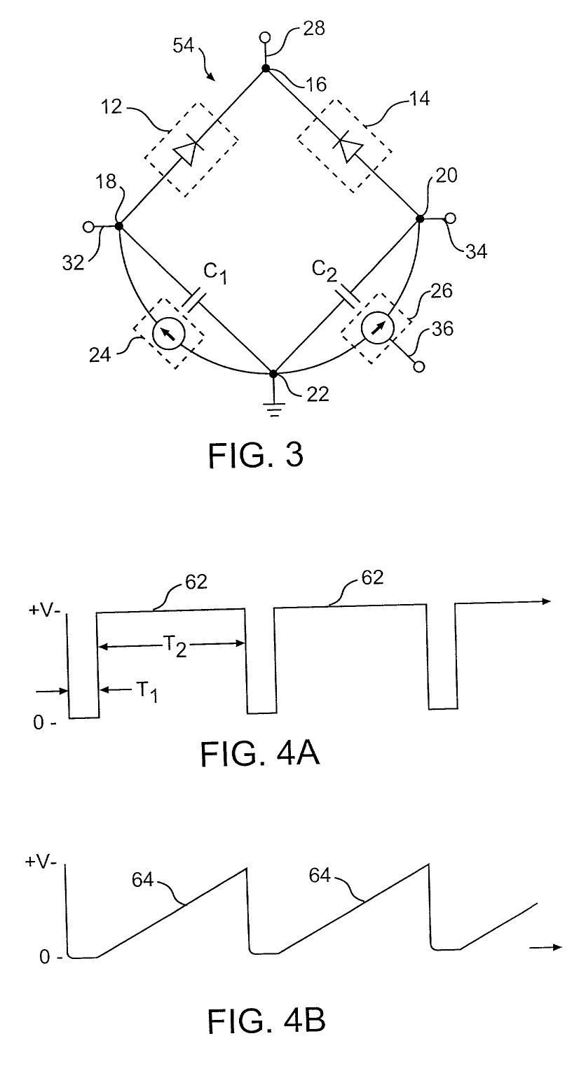

In bridge network 10 of FIG. 1, capacitors C₁ and C₂ are discharged from an initial voltage of substantially +V. However, all the advantages of the capacitive measurement circuit of the present invention can be realized if capacitors C₁ and C₂, in a transposed bridge network, are charged toward a voltage +V during time T₂ and rapidly discharged during a shorter time T₁. Such a transposed bridge network is generally shown by reference numeral 54 in FIG. 3. Circuit 54 has the identical construction of circuit 10 of FIG. 1, only the polarity of isolation means 12 and 14 and current sourcing means 24 and 26 is reversed. FIG. 4A shows a train of periodic pulses 62 of amplitude +V applied to excitation voltage terminal 28. The resulting periodic voltage at nodes 18 and 20 are substantially identical and have the general contour of waveform 64 of FIG. 4B when capacitors C₁ and C₂ are of equal value and are charged by equal currents from current sourcing means 24 and voltage-controlled current sourcing means 26. When C₁ is not equal to C₂, the voltage between nodes 18 and 20 provides an error signal that can be used to null-balance bridge network 54.

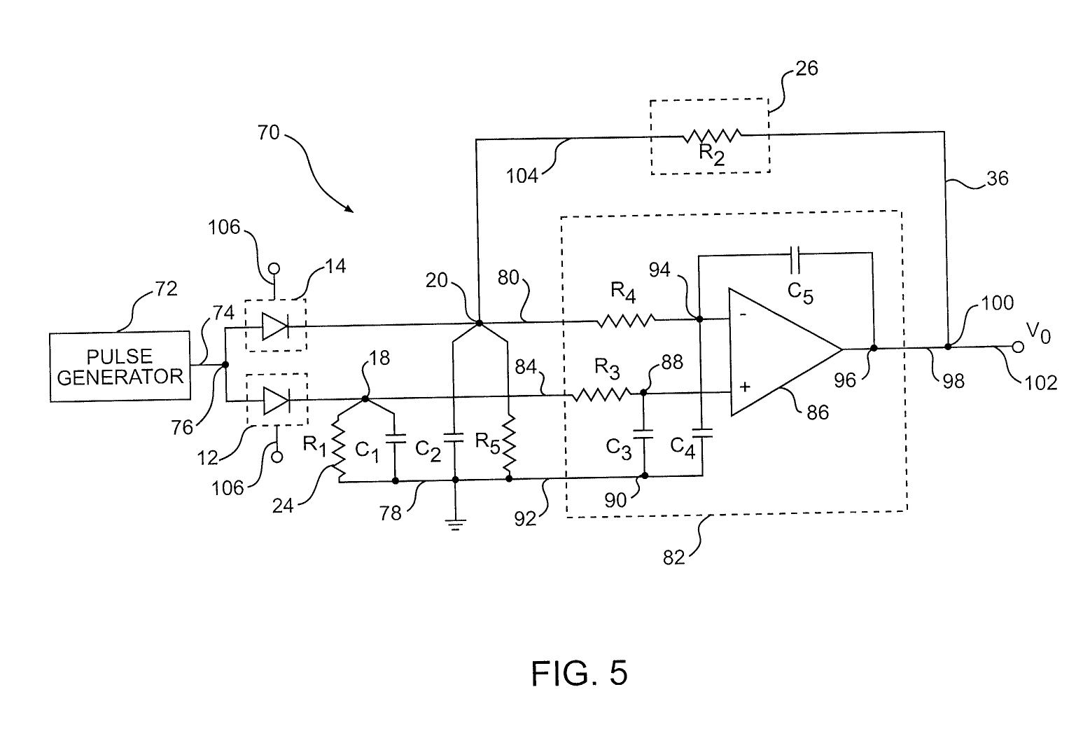

FIG. 5 shows a preferred embodiment of a capacitance measurement circuit generally shown by reference numeral 70. Circuit 70 is configured to measure the difference in capacitance between capacitors C₁ and C₂, where C₂ is a variable capacitor. Capacitor C₁ may be a fixed reference capacitor or a second variable capacitor. Pulse generator 72 is connected by output terminal 74 to input node 76 which is connected to isolation means 12 and 14. Isolation means 12 and one side of resistor R₁ and capacitor C₁ is connected to a first common node 18 and a second side of resistor R₁ and capacitor C₁ is connected to common return line 78. Resistor R₁ performs the function of current sourcing means 24 of FIG. 1. Isolation means 14 and one side of capacitor C₂ and optional resistor R₅ is connected to a second common node 20. A second side of capacitor C₂ and resistor R₅ is connected to return line 78 connected to a reference potential. A first input terminal 80 of an amplifying means 82 is connected to node 20 and a second input terminal 84 of opposing polarity of amplifying means 82 is connected to node 18. Amplifying means 82 includes amplifier 86 and capacitor C₅ and may optionally include resistors R₃ and R₄ and capacitors C₃ and C₄. Resistor R₃ is connected between terminal 84 and internal node 88 connected to capacitor C₃ connected to internal node 90. Node 90 is connected to ground terminal 92 of amplifying means 82 connected to return line 78. Resistor R₄ is connected between terminal 80 and internal node 94 connected to capacitor C₄ connected to node 90. When resistors R₃ and R₄ and capacitors C₃ and C₄ are not included in amplifying means 82, terminal 80 is directly connected to node 94 and terminal 84 is directly connected to node 88. A first input of amplifier 86 is connected to node 94 and a second input of opposing polarity of amplifier 86 is connected to node 88. Capacitor C₅ is connected between node 94 and internal node 96 connected to an output of amplifier 86. An output terminal 98 of amplifying means 82 is connected between node 96 and external node 100 connected to output voltage terminal 102. A control terminal 36 of voltage-controlled current sourcing means 26 is connected to node 100 and an output terminal 104 of current sourcing means 26 is connected to node 20. For this circuit embodiment, the function of the voltage-controlled current sourcing means 26 is performed by resistor R₂, a two-terminal, transconductance transducer.

The operation of circuit 70 is first described without resistor R₅, an optional gain adjusting element. Low-pass filtering of the periodic voltages at nodes 18 and 20 waveforms before amplification reduces the voltage excursions at the inputs to amplifier 86 and avoids the requirement to amplify bridge excitation frequencies. Optional resistor R₃ and capacitor C₃ comprise a first low-pass filter with a corner frequency f₁=1/(2πR₃C₃) and optional resistor R₄ and capacitor C₄ comprise a second low-pass filter with a corner frequency f₂=1/(2πR₄C₄) when C₄ is much greater than C₅. Generally, f₁ and f₂ are selected to be equal at a value below the excitation frequency of generator 72. The low-pass, RC filters are in effect passive integrator circuits and the desired filtering alternately could be performed using active filters or active integrator circuits. For wide bandwidth capacitive transducers, it is not necessary or always desirable to provide filtering before amplification. Capacitor measurement circuits can be constructed without low-pass filtering when amplifier 86 has sufficient gain and phase margin at the excitation frequency of generator 72.

When generator 72 provides excitation pulses of the contour of pulse 40 of FIG. 2A, a periodic voltage at node 18 has a general exponential contour of waveform 50 of FIG. 2D. When C₁=C₂ and R₁=R₂, current discharged by R₁ to return line 78 at said reference potential substantially equals the current sunk by R₂ to node 100. When Capacitor C₂ increases by ΔC, the asymptote of the exponential waveform on node 20 becomes Vₒ−ΔV and resistor R₂ sinks a current i+Δi. For the case where ΔC=100% and ΔV=½V⁺, the periodic voltage at node 20 has the contour of waveform 52 of FIG. 2D.

A change in voltage ΔV at terminal 102 for a change in capacitance ΔC can be expressed as:

$$\begin{matrix}Δ V \approx {KiR}_{2} Δ \frac{C}{C} \\ \approx {KV}_{p} Δ \frac{C}{C}\end{matrix}$$

where,

K=T₂/(T₁+T₂) the duty cycle of the capacitor discharge period,

i=average quiescent discharge current through resistor R₂,

Vₚ=magnitude of voltage step 44 of FIG. 2B.

Resistor R₂ performs the function of a two-terminal, voltage-controlled current sourcing means 26 of FIG. 1 that has a transconductance gain 1/R₂ in dimensions of mhos.

### Optional Embodiments

The gain of circuit 70 can be increased by adding optional resistor R₅ between node 20 and return line 78, whereby ΔV≈(1+R₂/R₅)VₚΔC/C. If the parallel resistance of R₂ and R₅ equals R₁ and C₁=C₂, the output voltage Vₒ will be substantially zero with respect to said reference potential and the gain of circuit 70 will increase by two. Alternately, the parallel resistance of R₂ and R₅ can be made smaller than R₁ to bias Vₒ to a positive quiescent value to increase the output swing of circuit 70 to accommodate large capacitive changes.

If capacitor C₂ of capacitance measurement circuit 70 has a low quiescent value, a higher value reference capacitor C₁ can be selected if the value of resistor R₁ is proportionately lower. This reduces the thermal noise associated with R₁ and also R₃ if it is also decreased.

Operating circuit 70, or its transposed circuit, at high excitation frequencies (e.g., 1 MHz and above) reduces the size and thermal noise contribution of resistors R₁, R₂, R₃, R₄ and optional resistor R₅ and allows an amplifier 86 with low voltage noise to be selected to reduce the total noise contribution of amplifying means 82.

The ratios R₃/R₁ and R₄/{(R₂R₅/(R₂+R₅)} can be as small a 2:1 to further reduce the source impedance at the inputs to amplifier 86 without a significant loss of capacitive sensitivity ΔV/ΔC.

Isolation means 12 and 14 of circuit 70, and its transposed circuit, can include Schottky diodes, PN-junction diodes, base-to-collector connected transistors; BJT, CMOS, MOSFET, or other types of electrical switches. When transistors or electrical switches are used, the on-off isolation function is required to be synchronously controlled by connecting a third control terminal 106 of isolation means 12 and 14 to an output of pulse generator 72.

Capacitor C₄ in circuit 70 can be relocated to replace feedback stabilization capacitor C₅ to form a well-known differential integrator circuit, but this arrangement has a disadvantage. Capacitor C₅ can be smaller than filter capacitor C₄ since capacitor C₅ only needs to stabilize the feedback loop. A smaller feed-back capacitor increases the open-loop gain of amplifying means 82 and enhances the DC stability of circuit 70.

Amplifying means 82 together with and resistor R₂ comprise a high-gain, differential voltage-to-current convertor, also known as a differential voltage-to-current converter or differential transconductance amplifier. Amplifying means 82 with capacitors C₁ and C₂ and resistors R₁ and R₂ together with resistor R₂ comprise a differential integrating transconductance amplifier.

The choice of voltage-controlled current sourcing means 26 may be based upon the required accuracy and polarity of the voltage-to-current conversation and the ease to fabricate the device as art of an integrated circuit. When voltage-controlled current sourcing means 26 has an output current of opposing polarity to an input control voltage, the polarity of the inputs of amplifying means 82 is required to be reversed to achieve negative feedback. High open-loop voltage gain is required ahead of voltage-controlled current sourcing means 26 to achieve the advantages of the capacitive measurement circuit and the transposed circuit of the present invention. The output of circuit 70 of FIG. 5 is inversely proportional to a change of capacitance because resistor R₂ is a non-inverting, voltage-controlled current sourcing means 26. This output relationship is reversed for the transposed circuit of circuit 70.

Voltage-controlled current sourcing means 26 in circuit 70, has a driving-point impedance equal to the value of resistor R₂. This causes the periodic voltage at node 20 of circuit 70 to have a periodic exponential contour similar to waveform 52 of FIG. 2D for large values of ΔC of variable capacitor C₂. When voltage-controlled current sourcing means 26 has a low conductance output characteristic of a current source, the voltage waveform at node 20 of circuit 70 has a periodic contour similar to waveform 46 of FIG. 2C and the above expression for ΔV is more exact.

When voltage-controlled current sourcing means 26 is a current source, current conveyor, or current mirror, it may be desirable to replace resistor R₁ of current sourcing means 24 with a fixed current source, current conveyor, current mirror or another type of transconductance transducer.

The DC stability and noise of the most accurate capacitive measurement circuits of the present invention were found to be limited by the low-frequency noise of a precision, low-noise, temperature-compensated, voltage reference IC that provided positive voltage +V to a crystal-controlled pulse generator. The output of the voltage reference was low-pass filtered using a large resistor and large tantalum capacitor with a high voltage rating compared to voltage +V to minimize noise and maximize dynamic range. The filtered reference voltage was buffered with a precision bipolar amplifier with picoamp input bias currents. Pulses with a 20% duty cycle were generated using a quartz tuning-fork oscillator, a micropower Pierce oscillator IC, and a bi-quinary connected CMOS ripple counter. Capacitive measurement circuits with a DC response were used to measure the dielectric integrity of thin-film insulating layers and capacitors. It was possible to detect random leakage and ion migration as it occurred with a resolution comparable to a capacitive change of 0.5 ppm (peak-to-peak) and less. All embodiments of the capacitive measurement circuits of the present invention can detect changes of the small capacitance of gap varying capacitive transducers; the size of Capacitor C₂ only is limited by the magnitude of parallel stray circuit capacitance at node 20.

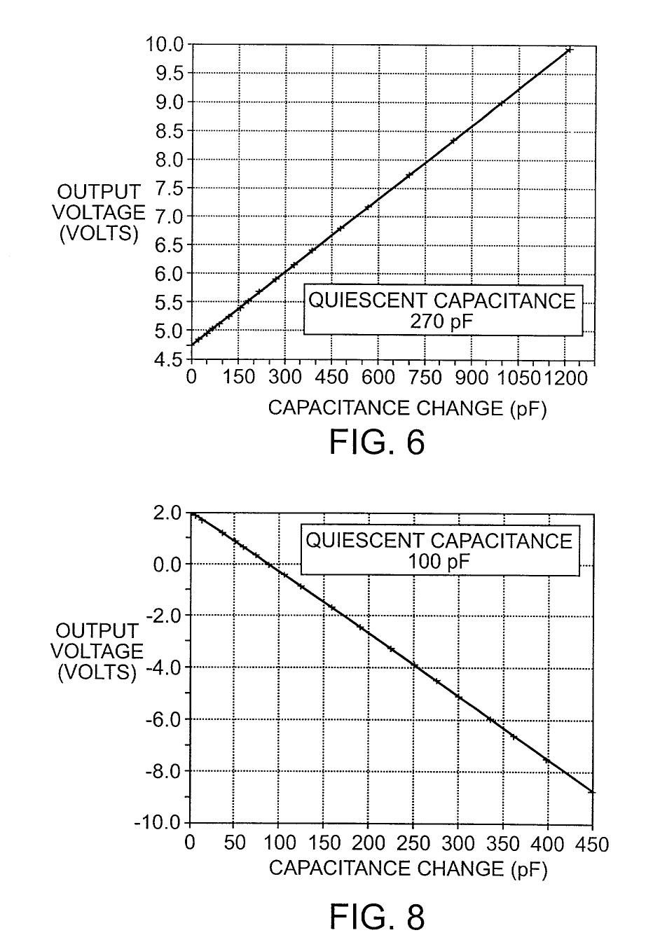

FIG. 6 is a plot of measured output voltage vs change in capacitor C₂ up to 440% for the transposed circuit of circuit 70. As C₂ increases, the output voltage to which C₂ charges increases to maintain the running average of the periodic voltages at nodes 18 and 20 substantially equal.

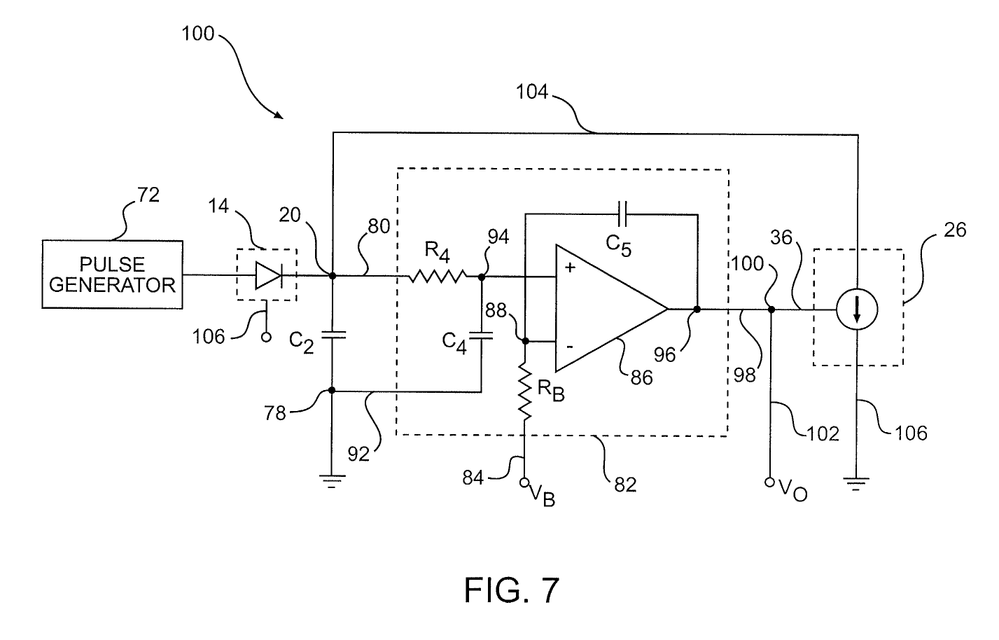

FIG. 7 is a simplified circuit diaphragm of a simpler and less accurate embodiment of a capacitive measurement circuit generally shown by numeral 100 that includes a half-bridge network in accordance with the present invention. For circuit 100, the polarity of the inputs of amplifying means 82 is reversed to accommodate an inverting voltage-controlled current sourcing means 26 which could comprise a simple base-driven transistor current source. Pulse generator 72 is connected to a first terminal of isolation means 14. A second terminal of isolation means 14 and one side of variable capacitor C₂ is connected to a first common node 20 and a second side of capacitor C₂ is connected to common node 78 connected to a reference potential. A first input terminal 80 of amplifying means 82 is connected to node 20. A second input terminal 84 of opposing polarity of amplifying means 82 is connected between an internal bias resistor R_{B} and an external source of bias voltage V_{B} more positive than said reference potential. Amplifying means 82 includes amplifier 86, capacitors C₄ and C₅, and resistors R₄ and R_{B}. Resistor R₄ is connected between input terminal 80 and internal node 94 connected to capacitor C₄ connected to node 78. A input terminal of Amplifier 86 is connected to node 94 and a second input terminal of opposing polarity of amplifier 86 is connected to internal node 88 connected to bias resistor R_{B}. Feedback capacitor C₅ is connected between node 94 and node 96 connected to an output of amplifier 86. An output terminal 98 of amplifying means 82 is connected between node 96 and external common node 100 connected to output voltage terminal 102. A control terminal 36 of voltage-controlled current sourcing means 26 is connected to node 100. An output terminal 104 and a reference terminal 106 of current sourcing means 26 is connected to node 20 and to a reference potential respectively. When a transistor or an electrical switch is used for isolation means 14, the on-off isolation function is synchronously controlled by connecting a third control terminal 106 of isolation means 14 to an output of pulse generator 72. When voltage-controlled current source 26 is a resistor, terminal 106 is not used.

The operation and feedback arrangement of circuit 100 is similar to circuit 70 of FIG. 5. Circuit 100 is simpler as it includes a half-bridge type network without isolation means 12, a reference capacitor C₁, and a second integrating circuit that comprises resistor R₃ and capacitor C₃. The voltage on terminal 84 of amplifying means 82 is a fixed bias voltage V_{B} rather than a running average of a periodic voltage across a reference capacitor. Pulse generator 72 has an output of periodic pulses substantially of the contour of pulse 40 of FIG. 2A. The function of isolation means 14, amplifying means 78, and voltage-controlled current sourcing means 26 are the same as those identified for identically numbered elements of circuit 70 of FIG. 5. Current fed back to node 20 maintains a running average of a periodic voltage across capacitor C₂ at node 20 substantially equal to bias voltage V_{B}. A change in output voltage ΔV at terminal 102 for a change in capacitance ΔC of capacitor C₂ can be expressed as:

$$\begin{matrix}Δ V \approx K \frac{i}{{g}_{m}} \cdot \frac{Δ C}{C} \\ \approx {KV}_{p} Δ \frac{C}{C}\end{matrix}$$

where,

K=the duty cycle of the capacitor discharge period,

i=average quiescent current of current sourcing means 26,

gₘ=the transconductance of current sourcing means 26,

Vₚ=quiescent programming or control voltage of current sourcing means 26.

If a resistor R₂ is used for voltage-controlled current source 26 then gₘ=1/R₂. For circuit 70, ΔV is substantially linear with increasing values of ΔC. The polarity of the output voltage reverses for the transposed circuit of circuit 100 in which isolation means 14 is reversed, voltage-controlled current sourcing means 26 sources current, and the output of pulse generator 72 has repetitive pulses generally of the contour of pulse 62 of FIG. 4A.

FIG. 8 is a typical plot of output voltage vs. capacitance for circuit 100 with voltage-controlled current sourcing means 26 comprising a resistor. Since a resistor is a non-inverting current sourcing means, the polarity of amplifying means 82 was reversed and output voltage Vₒ decreases with increasing capacitance.

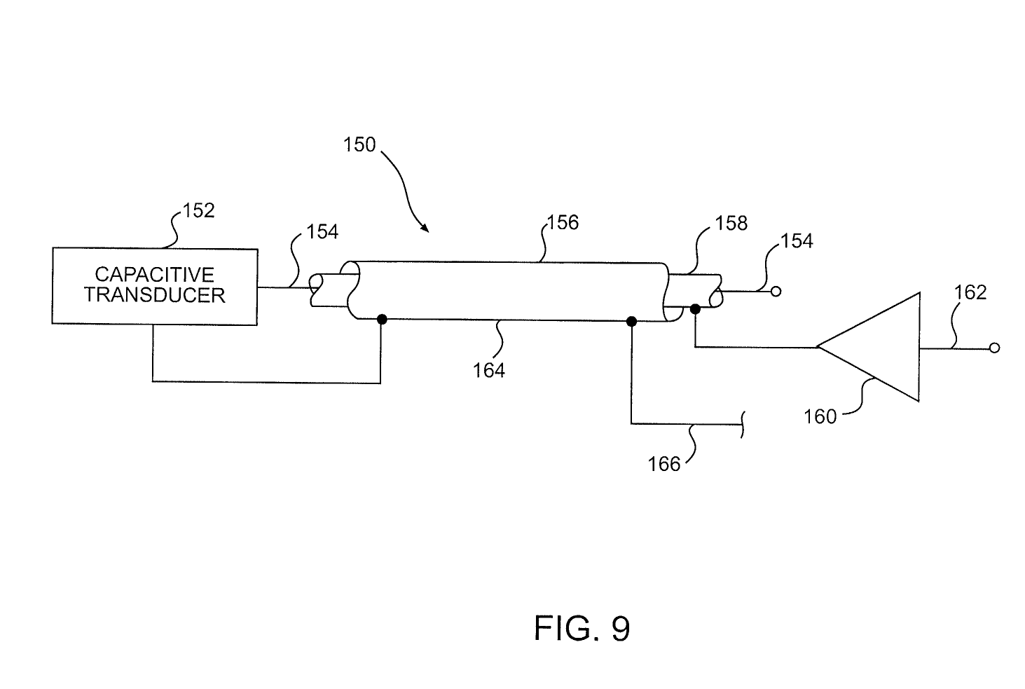

FIG. 9 shows an active shield circuit arrangement generally shown by reference numeral 150 that can be used with capacitive measurement circuit 70 of FIG. 5 or its transposed circuit to isolate the circuits inputs from stray electrical fields and to minimize signal loss due to parasitic capacitances. Capacitive transducer 152 replaces capacitor C₂ of circuit 70. Transducer 152 is connected to an input end of center conductor 154 of a triaxial cable 156 and an output end of center conductor 154 is connected to node 20 of circuit 70. Conductor 154 is shielded by active coaxial shield 158 connected to an output of unity-gain buffer amplifier 160. An input terminal 162 of amplifier 160 is connected to node 18 of circuit 70. Active shield 158 is shielded by outside ground shield 164 of triaxial cable 156 which is connected between transducer 152 and terminal 166 connected to return line 78 of circuit 70. This method of active shielding is very effective because the periodic signal voltage on center conductor 154 is substantially identical to the periodic voltage on active shield 158 because feedback maintains substantially equal voltage waveforms on nodes 18 and 20 of circuit 70. For short lengths of cable 156, buffer amplifier 160 can be deleted and active shield 158 connected directly to node 18 of circuit 70, whereby capacitance between active shield 158 and outside shield 164 is incorporated in parallel with reference capacitor C₁ of circuit 70.

While this invention has been described with reference to illustrative embodiments, various changes and modifications can be made to the disclosed embodiments without deviating from the concepts and scope of this invention. The full scope of this invention should be determined by the appended claims and their legal equivalents, rather than by the disclosed embodiments.

What is claimed is:

1. An electrical circuit that measures a difference in capacitance between a first capacitor and a second capacitor comprising:
a. a generator of periodic pulses of positive amplitude with respect to a reference potential connected to a first node connected to a first terminal of a first and a second isolation means;
b. said isolation means having a low-impedance conducting state when a voltage across said isolation means is positive with respect to said reference potential and a high-impedance non-conducting state when said voltage across said isolation means is substantially at said reference potential;
c. a second terminal of said first isolation means connected to a second node, and said first capacitor and a current sourcing means connected in parallel between said second node and a return line connected to said reference potential;
d. a second terminal of said second isolation means connected to a third node connected to said second capacitor connected to said return line;
e. a first input terminal of an amplifying means connected to said second node and a second input terminal of opposing polarity of said amplifying means connected to said third node;
f. an output terminal of said amplifying means connected to a fourth node connected to an output voltage terminal and to a control terminal of a voltage-controlled current sourcing means with an output terminal connected to said third node, whereby current fed back to said third node maintains an average of a periodic voltage at said third node substantially equal to an average of a periodic voltage at said second node and an output voltage of said amplifying means is proportional to said capacitance of said variable capacitor.

2. The electrical circuit of claim 1 wherein said current sourcing means and said voltage-controlled current sourcing means are resistors.

3. The electrical circuit of claim 1 wherein said amplifying means includes an amplifier and a first and second integrator circuit.

4. The electrical circuit of claim 1 wherein said current sourcing means is selected from the group consisting of a resistor, a transistor current source, a transistor current conveyor, a multiple transistor current source, a fixed voltage-to-current convertor, and a voltage-biased current mirror.

5. The electrical circuit of claim 1 wherein said voltage-controlled current sourcing means is selected from the group consisting of a resistor, a voltage-controlled current source, a voltage-controlled current conveyor, a voltage-programmed current convertor, and a voltage-controlled current mirror.

6. The electrical circuit of claim 1 wherein said first and said second isolation means are selected from the group consisting of a PN junction diode, a Schottky diode, and a transistor.

7. The electrical circuit of claim 1 further including a control terminal of said first and said second isolation means connected to an output of said generator of periodic pulses and said first and said second isolation means selected from the group consisting of a BJT switch, a CMOS switch, and a MOSFET switch.

8. The electrical circuit of claim 1 further including an active shield connected between said first and said third common node.

9. The electrical circuit of claim 3 wherein said first and said second integrator circuits comprise low-pass filter networks that include a resistor and a capacitor.

10. An electrical circuit that measures a capacitance of a variable capacitor comprising:
a. a generator of periodic pulses of positive amplitude with respect to a reference potential;
b. an output of said generator connected to a first terminal of an isolation means, said isolation means having a low-impedance conducting state when a voltage across said isolation means is positive with respect to said reference potential and a high-impedance non-conducting state when said voltage across said isolation means is substantially at said reference potential;
c. a second terminal of said isolation means connected to a first node connected to said variable capacitor connected to said reference potential;
d. a first input terminal of an amplifying means connected to said first node and a second input terminal of opposing polarity of said amplifying means connected to a bias voltage;
f. an output of said amplifying means connected to a third node connected to an output voltage terminal and to a control terminal of a voltage-controlled current sourcing means with an output terminal connected to said first node, whereby a current is fed back to said first node to maintain an average of a periodic voltage at said first node substantially equal to said bias voltage and an output voltage of said amplifying means is proportional to said capacitance of said variable capacitor.

11. The electrical circuit of claim 10 wherein said current sourcing means and said voltage-controlled current sourcing means are resistors.

12. The electrical circuit of claim 10 wherein said amplifying means includes an amplifier and an integrator circuit.

13. The electrical circuit of claim 10 wherein said current sourcing means is selected from the group consisting of a resistor, a transistor current source, a transistor current conveyor, a multiple transistor current source, a fixed voltage-to-current convertor, and a voltage-biased current mirror.

14. The electrical circuit of claim 10 wherein said voltage-controlled current sourcing means is selected from the group consisting of a resistor, a voltage-controlled current source, a voltage-controlled current conveyor, a voltage-programmed current convertor, and a voltage-controlled current mirror.

15. The electrical circuit of claim 10 wherein said first and said second isolation means are selected from the group consisting of a PN junction diode, a Schottky diode, and a transistor.

16. The electrical circuit of claim 10 further including a control terminal of said isolation means connected to an output of said generator and said isolation means selected from the group consisting of a BJT switch, a CMOS switch, and a MOSFET switch.

17. The electrical circuit of claim 10 wherein said first and said second integrator circuits comprise low-pass filter networks that include a resistor and a capacitor.

18. A capacitive bridge network comprising:
a. a first node connected to a first terminal of a first and second isolation means, said isolation means having a low-impedance conducting state when a voltage across said isolation means is positive with respect to a reference potential and a high-impedance non-conducting state when said voltage across said isolation means is at said reference potential;
b. a second terminal of said first isolation means connected to a second node connected to a first capacitor connected to a third node to form a first side of said bridge network and a second terminal of said second isolation means connected to a fourth node connected to a second capacitor connected to said third common node to form a second side of said bridge network.
c. Said first node connected to a source of periodically varying voltage having a positive peak amplitude with respect to said reference potential connected to said third node;
d. a fixed current sourcing means connected between said second and said third nodes and a voltage-controlled current sourcing means connected between said fourth and said third nodes and said voltage-controlled current sourcing means having a voltage control terminal.

19. The electrical circuit of claim 10 wherein said current sourcing means and said voltage-controlled current sourcing means are resistors.

20. The electrical circuit of claim 10 further including a differential integrating transconductance amplifier with inputs connected to said second and said fourth nodes and an output connected to said fourth node.
